(19) United States
(12) Patent Application Publication
(10) Pub. No.: US 2006/0060149 A1
(43) Pub. Date: Mar. 23, 2006

(54) Spill-resistant drinking container for animals

(75) Inventor: Richard Skowronski, North Hampton, NH (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(73) Assignee: Response Engineering, Inc., North Hampton, NH (US)

(21) Appl. No.: 11/231,197

(22) Filed: Sep. 20, 2005

Related U.S. Application Data
(60) Provisional application No. 60/612,312, filed on Sep. 23, 2004.

(51) Int. Cl. A01K 5/01

(52) U.S. Cl. 119/61.55

(57) ABSTRACT

A spill-resistant fluid container includes a chamber for holding a quantity of fluid. Within the chamber is a plurality of cavities. The cavities are circumferentially arranged so as to define a central chamber area. Each of the cavities have at least one opening so that the plurality of cavities are in restricted fluid communication with the central chamber area. Optionally, the container includes a removable top section having an inner-lip portion with a substantially flat inner surface defining an oblong opening, the inner surface being either parallel with the outer wall of the chamber, or angled upward away from the chamber. The top section also has an outer-lip portion spanning from a top edge of the outside wall of the chamber to a bottom edge of the inner-lip portion.

### CROSS-REFERENCE TO RELATED APPLICATIONS

This application is based upon and claims priority from U.S. Provisional Patent Application No. 60/612,312, filed on Sep. 23, 2004 the entire disclosure of which is herein incorporated by reference.

### BACKGROUND OF THE INVENTION

1. Field of the Invention

The present invention relates generally to non-spill refreshment containers, and more particularly relates to spill-resistant fluid containers for pets.

2. Background of the Invention

Pet owners frequently travel with their pets in motor vehicles, whether for necessity (e.g. veterinary visits), or for pleasure (e.g. vacation). Methods of travel include automobile, plane, train, boat, and other motor vehicles.

Many animals, particularly dogs, rely on panting to dissipate heat, which is accompanied by evaporation of moisture causing dehydration. With many pets, the combination of high metabolism and a thick fur coat causes the pet to pant at moderate, or even cool ambient temperatures. Even moderate panting can cause dehydration requiring frequent drinks of water. Lack of adequate water can cause the animal to dehydrate and overheat, resulting in severe physical trauma and even death. Therefore, if the trip is expected to last more than a few minutes, it would be prudent to bring along a bowl of water, especially if the weather is warm.

Some owners attempt to have water in the vehicle at all times so it is always available for the pet. Unfortunately, placing a water bowl in a vehicle frequently results in spills from the water sloshing around in the bowl due to vehicle motion. Even if the bowl is only half full, typical vehicle motions such as starts, stops, turns and bumps can cause the water to slosh, creating waves which exceed the height of the bowl rim. Spills can soak into the vehicle carpet resulting in the growth of molds, mildew, odors, and rust of the vehicle body. Previous efforts to reduce spills in vehicles have focused primarily on beverage containers for human use and little effort has been dedicated to pet water containers.

One obvious previous solution that provides water to pets without the potential of spilling liquid in the vehicle is to provide water to the pet only when the vehicle is stopped, and remove the water when the travel resumes. While this method certainly avoids sloshes and spills, the pet may not receive adequate water. Pets are often excited at the start and end of a trip and may be too preoccupied with the people and events to drink adequate water. A dehydrated pet may also drink too much water too fast resulting in the animal becoming sick. In addition, on long trips, infrequent water stops may result in poor time coordination with the pet's need for water and need to urinate. It is clear that a need exists for a water container that can be used in a moving motor vehicle and resists spills due to splashing and sloshing.

One attempt to address the need for a mobile dog bowl is a fabric bowl sewn in a bowl shape with the opening at the top of the bowl somewhat smaller than the bottom of the bowl. The fabric is either covered with a waterproof coating or layered with a waterproof material.

These fabric bowls are light and fold neatly to save space when not needed. Because the opening at the top is slightly smaller than at the bottom of the bowl, if the container is half full or less, it resists spills resulting from waves and splashes.

However, the soft sides of these bowls make them a natural spill-risk if they are filled more than about half way. Since only about half the bowl volume is useable, the size of the bowl must be larger to compensate. The soft sides and bottom of the bowl make it necessary to place the bowl on a rigid level surface, typically in an area where the pet might walk. As a result, the pet can step on the soft side of the bowl, flattening the side and spilling the entire contents of the bowl.

Another attempt to minimize spilling is to add an inward facing lip to the bowl. These bowls (sometime known as “Spill-Less” bowls or “SmartBowls”) have a smoothly curved lip around the rim facing inward toward the center of the bowl. When the bowl is subjected to a sudden movement, the resulting wave travels under the lip before striking the side of the bowl. As the wave hits the side of the bowl the resulting splash moves upward under the lip and is redirected toward the center of the bowl instead of spilling over the edge and out of the bowl.

While these bowls are much better at resisting spills due to sloshing than conventional bowls, they are only moderately effective. The inherent problem is that in order to accommodate the lip, the opening in the top of the bowl must be significantly smaller than the diameter of the bowl. As a result, the bowl contains a volume of fluid much greater than the opening in the top of the bowl would otherwise dictate. When subjected to motion, the large volume of fluid in motion and its energy result in larger waves that easily overwhelm the inward-facing lip. Moderate motion causes a severe wave that is taller than the lip and simply sloshes over the side of the bowl. Also, shorter severe waves that travel under the lip and are redirected by the inward facing lip back toward the center of the bowl with enough energy to cause a splash over the opposite side of the bowl.

Coffee mugs designed for automotive use also resist spills due to vehicle movement. While there are many designs of mobile coffee mugs, all involve small openings in the top that allow fluid to flow at moderate rates when the mug is tilted, as in the human drinking process. The openings are small enough to prevent rapid fluid flow that may spill or splash over the rim of the container. These prior art containers are not applicable to the pet or animal markets since pets cannot tilt the container to drink. Pets require a large opening in the top of the container to access the water for drinking.

Accordingly, a need exists for an open-top fluid container that can effectively resist spills due to motion, one specific application being a water bowl for pets in a moving vehicle. Also, such a container must be efficient in size and fluid capacity to be appropriate for confined spaces such as motor vehicles and pet carriers.

There is also a need for a method or system to mount this type of container in a vehicle that reduces the likelihood that a pet will step in it or on it causing the container to spill. This mounting system should also allow placement of the container in a location easily accessible by a pet. Ideally this mounting method would be inexpensive, simple, and reduce the vehicle floor space consumed by the container.

### SUMMARY OF THE INVENTION

A spill-resistant fluid container is described herein, which includes a liquid-holding chamber that has a plurality of cavities within the chamber. The cavities are circumferentially arranged so as to define a central area with in the chamber. Each of the cavities has an opening so that the cavities are in fluid communication with each other. These cavities are open at the top to permit fluid to flow from one to adjacent cavities when waves exceed the height of the cavity walls.

In one embodiment of the present invention, the cavities are made of a plurality of baffles located within the chamber and arranged substantially concentric with an oblong outer wall of the chamber. The baffles are separated from each other so as to allow fluid to pass between them. A plurality of ribs is also located within the chamber. Each rib is located between, and arranged substantially perpendicular to, the outer wall of the chamber and a different one of the plurality of baffles.

In an embodiment of the present invention, each of the ribs has a height that is greater than the baffles.

In yet another embodiment of the present invention, the chamber has a top section with an inner-lip section that has a substantially cylindrical or curved inner surface defining an opening in the top section of the chamber. In one embodiment, the inner surface is substantially parallel with an outer wall of the chamber. In another embodiment, the inner surface is arranged at an angle defined by a line running from an outer wall of the chamber to a center point above the chamber.

The top section also has an outer-lip portion that spans from a top edge of the outside wall of the chamber to a bottom edge of the inner-lip portion. An upper edge of the inner-lip portion is approximately co-planar with the upper edge of the outer wall of the chamber. Furthermore, the outer-lip portion is provided with a plurality of openings.

In one more embodiment of the present invention, the top section of the chamber is removably attached to the chamber and the inner-lip portion is oblong in shape.

In other embodiments of the present invention, the container has a lower portion that extends from a bottom surface of the chamber, so that the container can be attached to various objects.

In still other embodiments of the present invention, the container has a lower portion that has fastening points adapted for accepting brackets, mounting hardware, and other accessories for mounting the container to animal cages, anti-tip platforms, bean-bag bases and other accessories.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a perspective view of a spill-resistant fluid container, according to one embodiment of present invention;

FIG. 2 is a bottom partially exploded view of the spill-resistant fluid container of FIG. 1 showing the lip portions incorporated into a removable top, according to one embodiment of the present invention;

FIG. 3 is a perspective top view of the bowl portion of the spill-resistant fluid container of FIG. 1 without the removable top lid, according to one embodiment of the present invention;

FIG. 4 is a top view of the spill-resistant fluid container of FIG. 1 in accordance with one embodiment of the present invention;

FIG. 5 is a side cross-sectional view of the spill-resistant fluid container along line 5-5 of FIG. 4, according to one embodiment of the present invention;

FIG. 6 is a side perspective view of the spill-resistant fluid container of FIG. 1 according to one embodiment of the present invention; and

FIG. 7 is a partially exploded side perspective view of the spill-resistant fluid container of FIG. 6, showing the lower portion removed.

### DETAILED DESCRIPTION OF THE EMBODIMENTS

While the specification concludes with claims defining the features of the invention that are regarded as novel, it is believed that the invention will be better understood from a consideration of the following description in conjunction with the drawing figures, in which like reference numerals are carried forward.

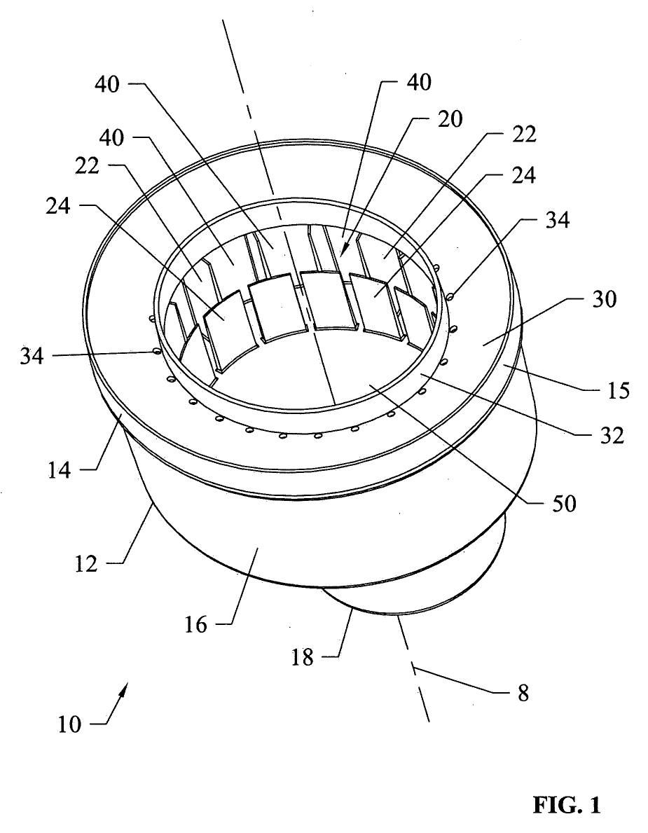

The following discussion is directed to preferred embodiments of spill-resistant fluid container that can be used as a pet water bowl. FIG. 1 shows a perspective view of the spill-resistant fluid container, according to one embodiment of present invention. The spill-resistant bowl assembly 10 includes a bowl portion 12 and a top section 14. In one embodiment, the top section 14 is removable from the bowl portion 12. In other embodiments, the top section 14 is permanently fixed to bowl portion 12.

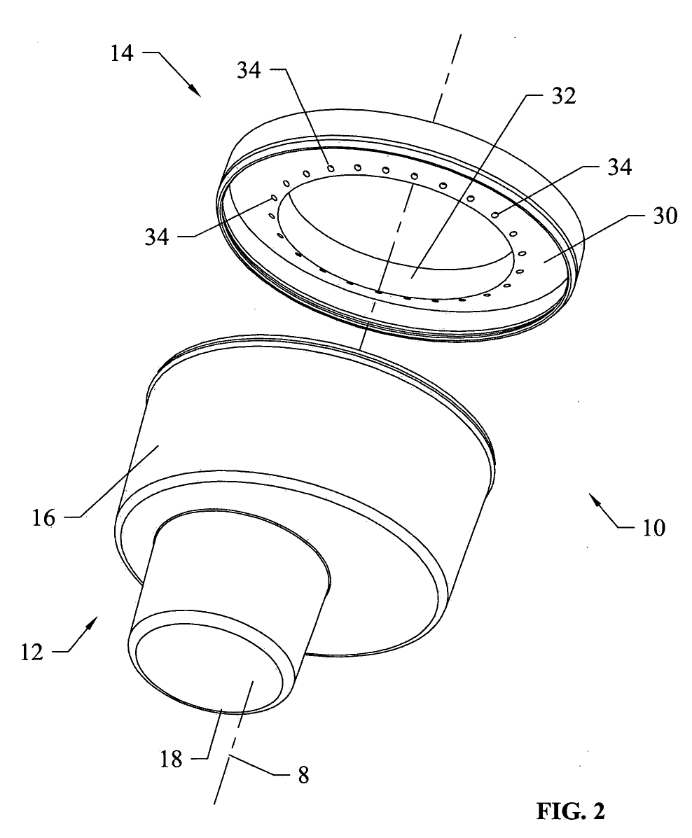

The bowl portion 12 includes a liquid-holding chamber 16 and lower mounting portion 18. An imaginary line 8, used herein to add clarity to this discussion, runs through the center of the bowl portion 12 and top section 14 and is shown in FIGS. 1 and 2. The liquid-holding chamber 16 and top section 14 are centered around the line 8.

Top section 14 has two main sub-portions: an outer lip portion 30 and an inner lip portion 32. Inner lip portion 32 resembles is a thin sleeve surrounding the imaginary line 8. In one embodiment, the inner lip portion 32 is orientated so that its inner surface is substantially parallel to the imaginary line 8. In another embodiment, the inner lip portion 32 is inclined upward towards the imaginary line 8 in a direction away from the inside cavity formed by the bowl section 12. The inner lip portion 32 acts as a barrier to prevent liquid from exiting the bowl section 12 by directing waves underneath both lip portions 30 and 32.

Outer lip portion 30 slants downward from an outermost perimeter wall 15 of the top section 14 toward the center of the bowl and terminates at a connection to a bottom edge of the inner lip 32. The configuration of the outer lip portion 30 and inner lip portion 32 resembles a V-shape and can be seen most clearly in the cross-sectional view of FIG. 5. The outer-lip portion 30 surrounds the inner-lip portion 32 and the outer-lip portion 30 is slanted to slope from an upper-edge of the outer wall 15 downward towards a bottom edge of the inner-lip portion. The V-shape causes an upper edge 52 of the inner-lip portion 32 to be generally co-planar with an upper portion 54 of the outer wall 15 of the top section 14 of the chamber 16. Other embodiments may vary slightly from a standard V-shape, but retain the general characteristics of that shown in FIG. 5 and are within the true spirit and scope of the present invention. The outer lip 30 should be of sufficient size to catch splashes that overcome inner lip portion 32. It is important to note, that in one embodiment, the outer wall 15 is eliminated in the top section 14 and the bowl portion 12 extends upwards and comprises upper portion 54.

The outer lip 30 is provided with a plurality of openings 34 adjacent the inner lip 32. The downward slant of the outer lip portion 30 redirects liquid that overcomes the inner lip 32 to the openings 34 and, therefore, back into the bowl. The openings 34 are large enough and are in sufficient quantity to allow fluid to drain rapidly, but not so large and numerous that waves under the lip portions can flow through fast enough and with enough energy to overwhelm the outer edge of top section 14. Holes 34 may alternatively be located in inner lip 32, or partially in both of lip portions 30 and 32 near the junction of these lip portions.

FIG. 2 shows a bottom partially exploded view of the spill-resistant fluid container of FIG. 1 showing the lip portions incorporated into a removable top, according to one embodiment of the present invention. Outer lip portion 30 slants downward from an outermost perimeter of the upper portion 14 toward the center of the bowl. As can be seen in FIG. 5, this slant creates a cavity 36 under the perimeter of top section 14. Cavity 36 provides an area for waves to move into instead of overwhelming the lip portions and spilling out of the bowl. As a wave strikes the inside wall of bowl portion 12, it naturally rebounds retaining much of its energy. The inclined shape of lip portion 30 causes much of the wave energy to be dissipated and/or redirected to the sides and downward rather than splashing back toward the center of the bowl where it may splash over the opposite edge of the bowl. Any residual splash back is stopped from splashing over the opposite edge of top section 14 by inner lip portion 32.

Optionally, as shown in FIG. 5, a barrier 38 consisting of ribs, fins, pins or similar features that protrude into cavity 36 can be added to the underside of lip portion 30. In certain applications, barrier 38 may be added to further dissipate the energy of a wave striking the inside wall of bowl portion 12.

Referring back to FIG. 2, it can be seen that bowl portion 12 consists of liquid-holding chamber 16 and lower mounting portion 18. Lower mounting portion 18 is advantageously sized to fit in a typical automotive cup holder so bowl assembly 10 does not need to be placed on the seat or floor of a vehicle. In one embodiment, the lower mounting portion 18 is offset from the liquid-holding chamber 16 so that the container is accommodated easily within the constraints of a cup holder or other mounting surface within a motor vehicle. Mounting bowl assembly 10 in a cup holder assures that the assembly is easily accessible to a pet while eliminating the need to place it on a vehicle seat or floor where a pet may kick it or step on it causing a spill.

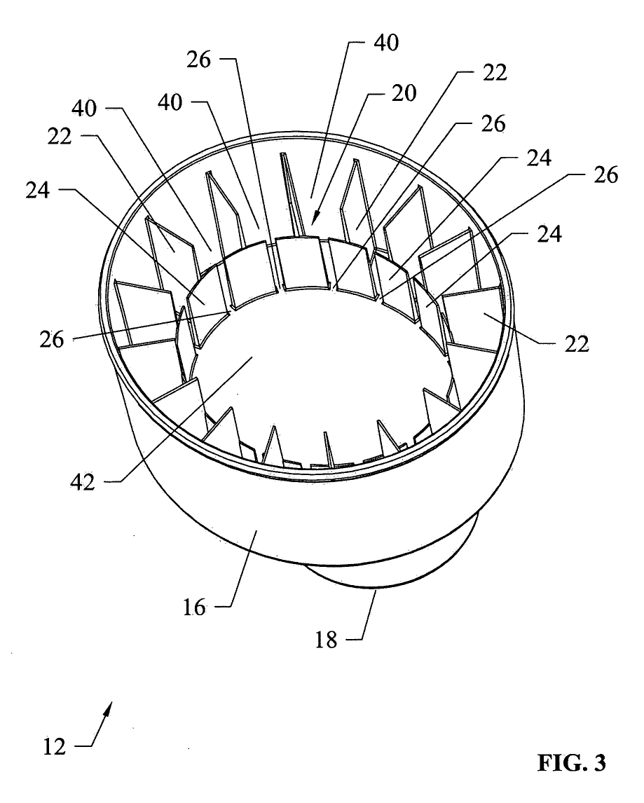

Turning now to FIG. 3, a perspective top view of the bowl portion 12 of the spill-resistant fluid container of FIG. 1 is shown without the removable top lid 14, according to one embodiment of the present invention. Wave dampeners 20 create perimeter cavities 40 between them. In the preferred embodiment, wave dampeners 20 consist of a series of radial ribs 22 and circumferential baffles 24 forming a series of perimeter cavities 40 along the inside perimeter of the bowl. Wave dampeners 20 are located so as not to interfere with a pet drinking and are therefore located mostly or entirely under lip portions 30 and 32. Wave dampeners 20 may be of different sizes and shapes extending in different directions, such as a series of circular or cylindrical ribs, to create similar perimeter cavities 40 without departing from the spirit and scope of the present invention. In one embodiment, the ribs 22 are taller than the baffles 24.

Wave dampeners 20 separate a large portion of the fluid volume in liquid-holding chamber 16 from an open top central chamber area 42. Since bowl volume is a function of the radius squared, a relatively large volume of fluid, approaching 20-80% of upper bowl 16 volume, can be separated from the main area or central chamber area 42 with modest sized perimeter cavities 40. It is important to note that other volumes of cavity 42 from 10-90% have been shown to be used advantageously with the present invention.

Wave dampeners 20 have small openings 26 that allow restricted fluid flow between perimeter cavities 40 and main cavity 42. Openings 26 are small such that the dynamic energy of the fluid in the perimeter cavities 40 does not contribute to the wave motion in main cavity 42. Additionally, limited or restricted fluid flow between adjacent perimeter cavities effectively prevents wave motion within and between perimeter cavities. As a result, when subjected to movement, the waves and the dynamic energy of the fluid in bowl assembly 10 is greatly reduced. While the figures show openings 26 in baffles 24, similar openings may also be used in ribs 22.

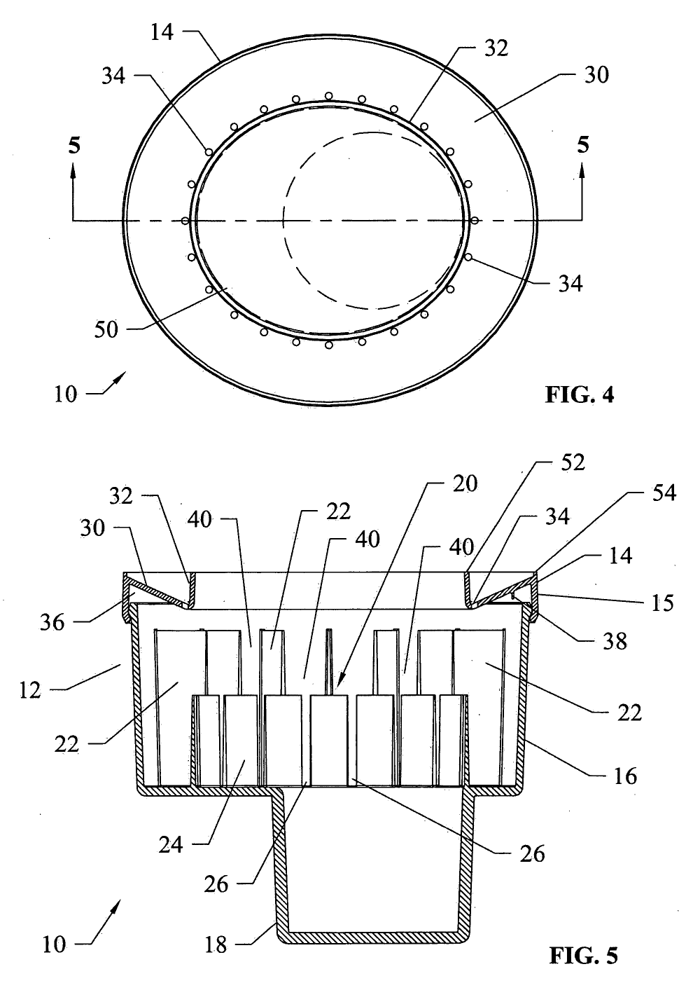

Referring now to FIG. 4, an opening 50 in top section 14 is preferably generally oblong or elliptical in shape to most efficiently accommodate the shape of an animal's snout when the animal is drinking. When an animal's mouth is closed, the height of the snout is approximately equal to the width. As an animal opens its mouth to drink, additional height is required. Minimizing the size of opening 50 further reduces the likelihood of spilling. The unequal length and width of opening 50 provides an optimum compromise between minimizing the size of opening 50 and providing adequate space for the animal to drink.

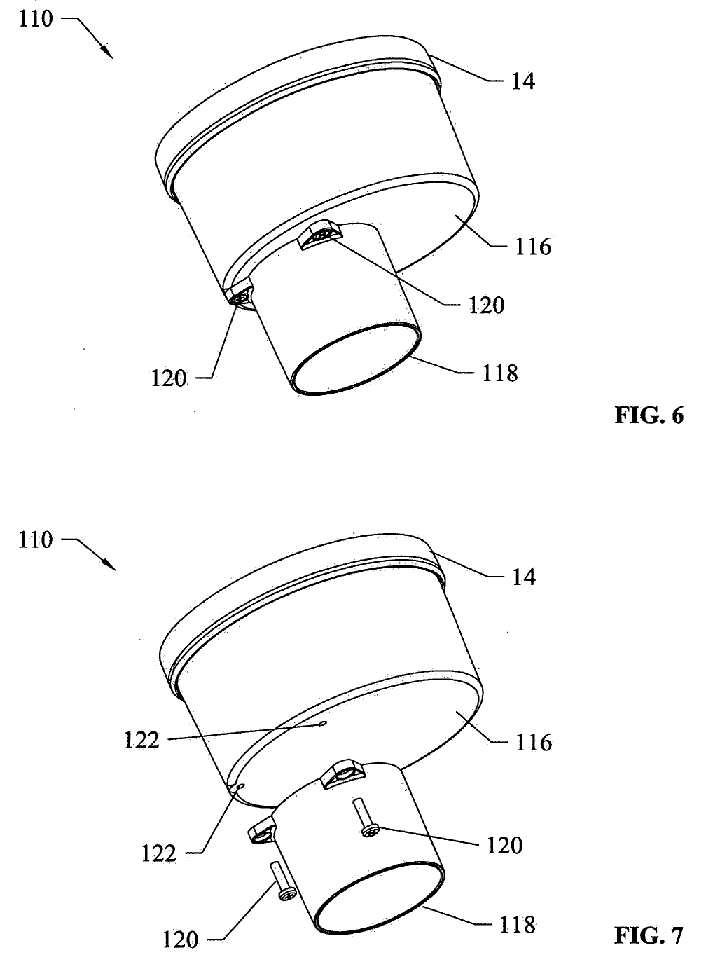

Reference is made now to FIGS. 6 & 7. FIG. 6 is a side perspective view of the spill-resistant fluid container of FIG. 1 according to one embodiment of the present invention, and FIG. 7 is a partially exploded side perspective view of the spill-resistant fluid container of FIG. 6, showing the lower portion 118 removed. Bowl assembly 110 is a variation of the present invention with a removable lower mounting portion 118. In FIG. 6, lower mounting portion 118 is fastened to liquid-holding chamber 116 with screws 120. As is understood by those skilled in the art, many other methods of fastening such as snap fits, screw threads, hook and loop fasteners, Velcro, glue and others can be used without departing from the spirit and scope of the invention. Removal of lower mounting portion 118, as shown in FIG. 7, allows the upper portion of bowl assembly 110 to be placed on a flat surface and used as a standard bowl. Also, the fastening points 122 in liquid-holding chamber 116 can be used to attach other mounting adapters allowing bowl assembly 110 to be mounted to other areas of a vehicle such as window openings, armrests, consoles, etc. In addition, adapters including brackets and other hardware can be made to accommodate mounting of bowl assembly 110 to animal travel containers and cages so water is available during transport in motor vehicles, trains, planes, boats, trailers, by hand, and the like. Adapters can include wide anti-tip platforms, bean-bag bases, anti-slip bases for smooth and/or carpeted surfaces and other accessories allowing bowl assembly 110 to be mounted or placed in almost any location.

The embodiment of the present invention depicted in the figures is designed to be molded in plastic polymer which is well suited for high volume, low cost production. Many of the features of this embodiment are designed to accommodate the molding process. For example, the openings 26 are depicted as narrow vertical slots to accommodate the molding process, even though a hole in baffle 24 near the bottom of the liquid-holding chamber would suffice, but be more difficult and costly to produce. Similarly, the shape, location, and thickness of the features of bowl 10 are all selected to accommodate the molding process while achieving the objectives of the invention. Other applications of this invention may result in very different variations to accommodate the specific application and processes. For example, an aircraft application may result in a container of the subject invention fabricated from thin aluminum sheet riveted or welded together. Such a variation may have different shapes, sizes and locations for openings 26 and wave dampeners 20 without departing from the spirit of the present invention.

The above figures and discussion describe a preferred embodiment of the present invention where the container is a pet water bowl for use in a moving vehicle. As is obvious from the above discussion, there are many other applications for the present invention, for example, soup pots for use in boats, trains, recreational vehicles (RVs) and aircraft.

In addition, the container can be constructed in various materials using various assembly methods. Features of the invention can be incorporated into a single part, or they can be assembled as many separate parts. For example, the pet bowl could be a single molded plastic part, while the present invention suited for high temperature-liquids may have a separate metal portion, separate fin, or perimeter cavity portion, and a separate top section. The above variations as well as other variations and applications obvious to those skilled in the art are within the scope of this invention. It is important to note that top portion 14 is removable from the bowl portion 12 and in another embodiment, the top portion 14 is permanently affixed to the bowl portion.

In one embodiment, the container has an attachable lid that will prevent fluid from exiting the container even if the container is turned upside down. In another embodiment, the container is provided with a surface location to label the animal's name. The location can be a flat surface for applying a sticker or can be an attachable label.

In some embodiments of the present invention, the lower mounting portion 18 is a water-tight chamber that is in fluidic communication with the liquid-holding chamber 16. The lower mounting portion can then be used as an extra liquid-holding reservoir. In variations of this embodiment, the lower mounting portion 18 can be provided with a heating element for heating the liquid or a cooling element for cooling the liquid. The lower mounting portion 18 can have an adapter to attach hot or cold packs. In yet another embodiment, the lower mounting potion 18 is provided with a stirring element for stirring the liquid in the chamber 16.

While the various embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A spill-resistant fluid container comprising:
a liquid-holding chamber; and
a plurality of cavities within the chamber, the cavities circumferentially arranged so as to define a central chamber area, each of the cavities having at least one opening so that the plurality of cavities have restricted fluid communication with the central chamber area.

2. The spill-resistant fluid container according to claim 1, wherein the cavities are open at the top for allowing free flow of fluid when a level of liquid exceeds a height of the cavities.

3. The spill-resistant fluid container according to claim 1, wherein the cavities comprise:
a plurality of baffles located within the chamber, arranged substantially concentric with an outer wall of the chamber, and separated from each other so as to allow fluid to pass between the baffles; and
a plurality of ribs located within the chamber, each rib arranged substantially perpendicular to the outer wall of the chamber.

4. The spill-resistant fluid container according to claim 3, wherein the plurality of ribs have a height that is greater than a height of the plurality of baffles.

5. The spill-resistant fluid container according to claim 1, further comprising:
a top section of the chamber;
an inner-lip portion defining an opening in the top section of the chamber, the inner-lip portion being at least one of:
substantially parallel with an outer wall of the chamber; and
arranged at an angle defined by a line running from an outer wall of the chamber to a center point above the chamber.

6. The spill-resistant fluid container according to claim 5, further comprising:
an outer-lip portion surrounding the inner-lip portion, wherein the outer-lip portion is slanted to slope from an upper-edge of the top section downward towards a bottom edge of the inner-lip portion creating a substantially V-shaped cross section of the top section.

7. The spill-resistant fluid container according to claim 6, wherein an upper edge of the inner-lip portion is approximately co-planar with the upper edge of the outer wall of the top section of the chamber.

8. The spill-resistant fluid container according to claim 6, further comprising:
a plurality of openings disposed in proximity to a junction of the inner-lip portion and outer-lip portion.

9. The spill-resistant fluid container according to claim 1, wherein the opening at the top of the container is substantially oblong in shape.

10. The spill-resistant fluid container according to claim 5, wherein the top section of the chamber is removably attached to the chamber.

11. The spill-resistant fluid container according to claim 1, further comprising:
a lower mounting portion extending from a bottom surface of the chamber, the lower portion adapted for mounting inside a cup holder of a motor vehicle.

12. The spill-resistant fluid container according to claim 1, wherein the chamber includes a bottom surface with one or more fastening points for fastening to a mounting device.

13. A spill-resistant fluid container comprising:
a chamber for holding a quantity of fluid;
a plurality of cavities within the chamber, the cavities circumferentially arranged so as to define a central chamber area, each of the cavities having at least one opening so that the plurality of cavities have restricted fluid communication with the central chamber area.
a top portion with a central opening created by at least one inward facing lip extending at least partially over the cavities.

14. The spill-resistant fluid container according to claim 13, wherein the cavities are formed with a top opening for allowing free flow of fluid when a level of fluid exceeds a height of the cavities.

15. The spill-resistant fluid container according to claim 13, further comprising:
a plurality of baffles located within the chamber, arranged substantially concentric with an outer wall of the chamber, and separated from each other so as to allow fluid to pass between the baffles;
a plurality of ribs located within the chamber, each rib arranged substantially perpendicular to the outer wall of the chamber.

16. The spill-resistant fluid container according to claim 13, further comprising:
a top portion with an inner-lip portion defining the opening in the top section of the chamber, the inner-lip portion being at least one of:
substantially parallel with the outer wall of the chamber; and
arranged at an angle defined by a line running from the outer wall of the chamber to a center point above the chamber.

17. The spill-resistant fluid container according to claim 16, further comprising:
a top portion with an outer-lip portion surrounding the inner-lip portion, wherein the outer-lip portion is slanted to slope from an upper-edge of the top section downward towards a bottom edge of the inner-lip portion creating a substantially V-shaped cross section of the top section.

18. The spill-resistant fluid container according to claim 17, further comprising:
a plurality of openings disposed in proximity to a junction of the outer lip portion and inner-lip portion.

19. The spill-resistant fluid container according to claim 13, wherein the central opening in the top portion is substantially oblong in shape.

20. The spill-resistant fluid container according to claim 15, wherein the plurality of ribs have a greater height dimension than a height of the plurality of baffles.

21. The spill-resistant fluid container according to claim 13, wherein the top section of the chamber is removably attached to the chamber.

22. A spill-resistant fluid container comprising:
a chamber for holding a quantity of fluid;
a plurality of cavities within the chamber, the cavities circumferentially arranged so as to define an open top central chamber area, each of the cavities having at least one opening so that the cavities have restricted fluid communication with the central chamber area, and wherein the cavities are formed with a top opening for allowing free flow of fluid when a fluid level exceeds a height of cavities; and
a top portion with a central opening created by at least one inward facing lip extending at least partially over the cavities.

23. A spill-resistant fluid container comprising:
a chamber for holding a quantity of fluid;
top section having at least one inward facing lip portion and an opening generally in the center of the top section; and
a generally cylindrical lower mounting portion projecting from a lower surface of the chamber suitable for securing the chamber in an automotive cup holder.

24. The spill-resistant fluid container of claim 23, wherein the lower mounting portion is removable from the lower surface of the chamber and replaceable with one or more accessories for mounting the chamber in other locations.
